(19) United States
(12) Patent Application Publication
(10) Pub. No.: US 2025/0158761 A1
(43) Pub. Date: May 15, 2025

(54) ACTION DELAY FOR A COMMON TRANSMISSION CONFIGURATION INDICATION (TCI) SWITCH

(71) Applicant: Apple Inc., Cupertino, CA (US)

(72) Inventors: Manasa Raghavan, Sunnyvale, CA (US); Jie Cui, San Jose, CA (US); Yang Tang, San Jose, CA (US); Huaning Niu, San Jose, CA (US); Yushu Zhang, Beijing (CN); Xiang Chen, Campbell, CA (US); Qiming Li, Beijing (CN); Dawei Zhang, Saratoga, CA (US)

(21) Appl. No.: 18/836,416

(22) PCT Filed: Feb. 11, 2022
(86) PCT No.: PCT/CN2022/076003

§ 371 Date: Aug. 7, 2024

(30) Foreign Application Priority Data
Feb. 11, 2022 (WO) PCT/CN2022/076003

(51) Int. Cl. H04L 5/00; H04W 72/231

(52) U.S. Cl. CPC H04L 5/001; H04L 5/0051; H04L 5/0053; H04W 72/231

(57) ABSTRACT

A user equipment (UE) is configured to communicate with a base station using a set of component carriers (CCs) configured for a carrier aggregation (CA) mode, in accord with a first common transmission configuration indication (TCI) identifier (ID) applied to the set of CCs. The UE is also configured to receive, from the base station, a command to switch from applying a first common TCI ID to the set of CCs to applying a second common TCI ID to the set of CCs; transmit, to the base station, an acknowledgement of the command to apply the second common TCI ID to the set of CCs; and transmit data to or receive data from the base station, using the set of CCs and in accord with the second common TCI ID, after an action delay including a first time period in which the acknowledgement is transmitted. The first time period is based on a smallest subcarrier spacing of the set of CCs.

### TECHNICAL FIELD

This application relates generally to wireless communication systems, including methods and systems for switching a common TCI identifier (ID).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example set of two configured CCs for a UE.

FIG. 2 shows an example timeline for a common TCI ID switch.

FIG. 3 shows an example method of a UE, which method may be used to switch a common TCI ID.

FIG. 4 shows an example method of a base station, which method may be used to switch a common TCI ID used by a UE.

FIG. 5 shows another example method of a UE, which method may be used to switch a common TCI ID.

FIG. 6 shows an example method of a base station, which method may be used to switch a common TCI ID used by a UE.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In 3GPP Rel-17, a TCI framework for unified beam management (BM) is described. In accord with the TCI framework, radio resource control (RRC) may identify a set of TCI states for each of a number of component carriers (CCs) that have been configured to a UE in a carrier aggregation (CA) mode. RRC may also configure a TCI state pool (i.e., a set of TCI states that can be shared among the set of configured CCs). To simplify beam management, a base station may provide, to a UE and in a medium access control (MAC) control element (CE) or downlink control information (DCI), a common TCI ID. The common TCI ID may identify a set of TCI states, in the TCI state pool, that is to be applied to the set of configured CCs. The common TCI ID may be associated with the same or different TCI states for different CCs.

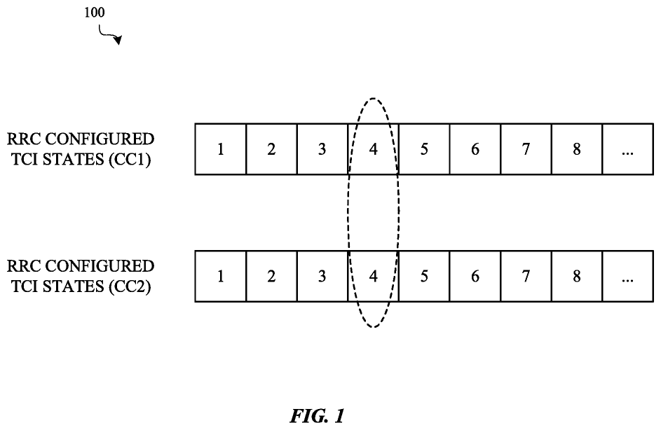

FIG. 1 shows an example set 100 of two configured CCs for a UE. The CCs are identified as CC1 and CC2. The RRC configured TCI state pool for the CCs includes TCI states that are consecutively number 1, 2, 3, 4, and so on for each CC. An example TCI ID 4 is associated with TCI state 4 for each of CC1 and CC2. TCI state 4 may be the same for both CC1 and CC2, or TCI state 4 may be different for each of CC1 and CC2.

If a TCI state pool is not configured for a bandwidth part (BWP) or CC, the TCI state pool configured for a reference BWP/CC can be used.

When the BWP/CC ID for a quasi-co-location (QCL) Type A/D (QCL-Type A/D) source reference signal (RS) in a QCL-Info of a TCI state is absent, a UE may assume that the QCL-Type A/D source RS is in the BWP/CC to which the TCI state applies.

For intra-band CA, a base station can provide a channel state information reference signal (CSI-RS) for BM, to provide a common beam indication (QCL-TypeD) for a set of configured CCs. Alternatively, the base station can provide a tracking reference signal (TRS) per CC for QCL-TypeD indication, and the TRSs may share a common QCL-TypeD source.

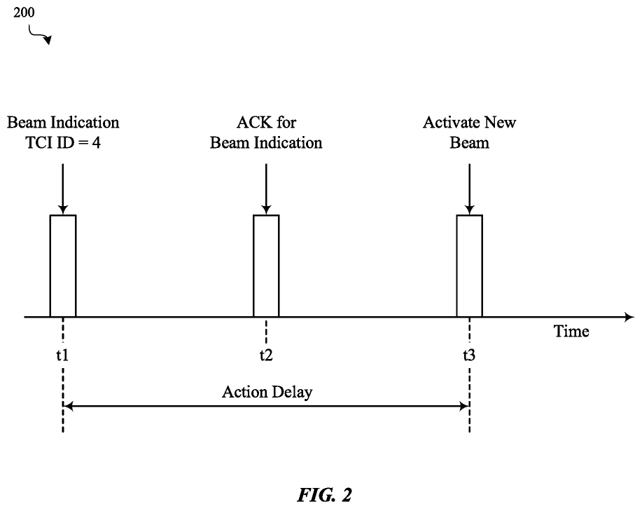

From time-to-time, a base station may switch the common TCI ID that is to be applied to a set of configured CCs for a UE. FIG. 2 shows an example timeline 200 for such a switch. At time t1, the UE may be communicating with the base station, in a CA mode, in accord with a first common TCI ID (e.g., common TCI ID 2). Also at time t1, the UE may receive, from the base station, a command to switch to a second common TCI ID (e.g., common TCI ID 4). In response to receiving the command, the UE may transmit, to the base station, an acknowledgement (ACK) of the command. The ACK may be transmitted at time t2, subsequent to time t1. Following transmission of the ACK, the UE may decode the second common TCI ID, optionally perform a receive (Rx) beam sweep, and perform other operations before the second common TCI ID is activated at time t3, subsequent to time t2. The time period between t1 and t3 is referred to as an action delay (i.e., a delay that is incurred before the UE can activate (or apply) the second common TCI ID to its uplink (UL) and/or downlink (DL) communications with the base station).

The action delay described with reference to FIG. 2 may vary and depends on a number of factors. For example, an action delay may vary depending on whether the second (or target) common TCI ID is associated with a TCI state/RS that is shared among a set of configured CCs (Case 1), or whether the target common TCI ID is associated with different TCI states/RSs for different CCs (Case 2). The action delay may also vary depending on the TCI mode of the target common TCI ID. For example, a target common TCI ID may be provided for a joint TCI mode (i.e., a mode in which the target common TCI ID is applied to a combination of UL and DL CCs), a DL TCI mode (i.e., a mode in which the target common TCI ID is applied to only DL CCs), or an UL TCI mode (i.e., a mode in which the target common TCI ID is applied to only UL CCs). The action delay may further vary depending on whether a TCI state associated with the target common TCI ID is known or unknown. The “known” condition for a DL TCI state is defined in 3GPP Technical Specification (TS) 38.133 § 8.10.2. The “known” condition for an UL TCI state has yet to be defined but may be based on information similar to the UL spatial relation information associated with DL-RS, as defined in 3GPP TS 38.133 § 8.12.2. The action delay may also vary depending on whether a command to switch to the target common TCI ID is received in a MAC CE or DCI.

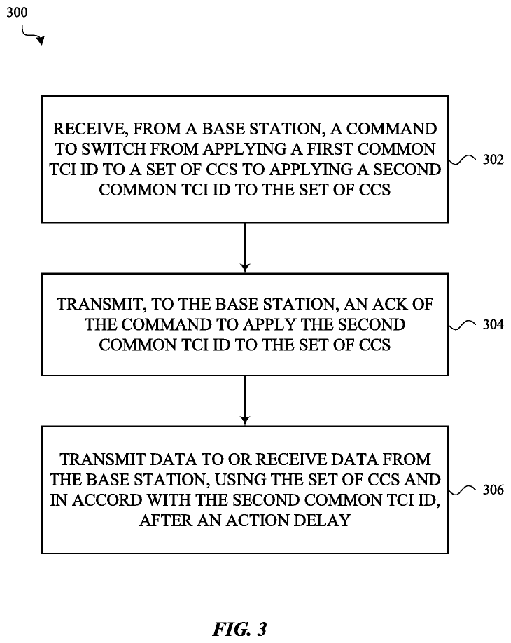

FIG. 3 shows an example method 300 of a UE, which method 300 may be used to switch a common TCI ID. At the start of the method 300, the UE may be configured to communicate with a base station using a set of CCs configured for a CA mode, in accord with a first common TCI ID applied to the set of CCs. The set of CCs may include DL CCs and/or UL CCs, and the first common TCI ID may be applied to DL CCs and UL CCs (in a joint TCI mode), to only DL CCs (in a DL TCI mode), or to only UL CCs (in an UL TCI mode).

At block 302, the method 300 may include receiving, from the base station, a command to switch from applying the first common TCI ID to the set of CCs to applying a second common TCI ID to the set of CCs.

At block 304, the method 300 may include transmitting, to the base station, an ACK of the command to apply the second common TCI ID to the set of CCs.

At block 306, the method 300 may include transmitting data to or receiving data from the base station, using the set of CCs and in accord with the second common TCI ID, after an action delay. The action delay may include a first time period in which the acknowledgement is transmitted at block 304. The first time period may be based on a smallest SCS of the set of CCs. The action delay may also be based on a smallest SCS of the set of CCs.

The method 300 may be adapted in various ways, depending on factors such as: whether the second common TCI ID is associated with a TCI state/RS that is shared among the set of CCs; the TCI mode of the second common TCI ID (e.g., a joint TCI mode, a DL TCI mode, or an UL TCI mode); whether a TCI state associated with the second common TCI ID is known or unknown; or whether a command to switch to the second common TCI ID is received in a MAC CE or DCI.

In some embodiments of the method 300, a RS may be shared by the CCs in the set of CCs according to the second common TCI ID. Because the RS is shared (i.e., the same), the set of CCs share a same QCL condition and a same “known” or “unknown” condition. The UE behavior for beam training will also be the same, and will be shared across all of the CCs. The command decoding time may be based on the CC with the smallest SCS, and the application time may be based on a beam switching time for joint DL/UL switching or separate DL or UL switching, depending on the TCI mode (e.g., a joint TCI mode, a DL TCI mode, or an UL TCI mode).

In a first embodiment of the method 300, in which a RS is shared by the CCs in the set of CCs, the second common TCI ID may be provided for a joint TCI mode. In this embodiment, the UE may simultaneously begin to switch the DL CCs and the UL CCs (in the set of CCs) to the second common TCI ID. The DL and UL switching may include different delay factors and, thus, the action delay may include a DL action delay and an UL action delay. In some cases, the method 300 may include receiving a downlink communication from the base station after the DL action delay, and transmitting an uplink communication to the base station after the UL action delay. In other words, the second common TCI ID may be activated for the DL CCs separately from the UL CCs (and vice versa). In some cases, the method 300 may alternatively include determining a maximum of the DL action delay and the UL action delay, and transmitting data to or receiving data from the base station after the maximum of the DL action delay and the UL action delay. The DL action delay and the UL action delay may be determined as described herein for cases where the second common TCI ID is provided for a DL TCI mode or an UL TCI mode.

In a second set of embodiments of the method 300, in which a RS is shared by the CCs in the set of CCs, the second common TCI ID may be provided for a DL TCI mode. The second set of embodiments may include a first subset of cases in which the command to apply the second common TCI ID is received in a MAC CE, and a second subset of cases in which the command to apply the second common TCI ID is received in DCI.

In the first subset of cases, in which the command to apply the second common TCI ID is received in a MAC CE, the action delay may include a second time period in which a MAC CE including the command received at 302 is decoded. The second time period may include the first time period. Optionally, the action delay may also include a third time period in which a Rx beam sweep is performed (i.e., a time for performing a Rx beam sweep) and/or a fourth time period in which a timing offset (TO) and a frequency offset (FO) are acquired (i.e., a TO/FO acquisition time). The second time period may be equal to T_{HARQ} plus 3 milliseconds (3 ms), where T_{HARQ} is the first time period (or a hybrid automatic repeat request (HARQ) time period). The third time period may be equal to T_{L1-RSRP} (i.e., a time for measuring a Layer 1 (L1) reference signal received power (RSRP) during a Rx beam sweep, to determine which beam is suitable to receive the RS associated with the TCI state associated with the second common TCI ID), and may be incurred (e.g., in FR2) when the TCI state associated with the second common TCI ID is unknown. The fourth time period may be equal to T_{first-SSB}+T_{SSB-proc}, and may be incurred when the second common TCI ID (or its associated TCI state) is not in an active list maintained by the UE. T_{first-SSB} is a time to a first synchronization signal block (SSB) for performing TO/FO measurements, and T_{SSB-proc} is a processing delay, such as 2 ms, for adjusting the TO/FO loops. When the TCI state associated with the second common TCI ID is known, the action delay may be equal to T_{HARQ}+3 ms+TOₖ*(T_{first-SSB}+T_{SSB-proc}), where TOₖ is 0 if the TO/FO is known and the second common TCI ID (or its associated TCI state) is in the active list, and 1 otherwise. When the TCI state associated with the second common TCI ID is unknown, the action delay may be equal to T_{HARQ}+3 ms+T_{L1-RSRP}+TOᵤₖ*(T_{first-SSB}+T_{SSB-proc}), where TOᵤₖ is 1 if the UE is not able to get the TO/FO during the T_{L1-RSRP} measurement, and 0 if the UE can get the TO/FO during the T_{L1-RSRP} measurement. T_{HARQ} is the time for transmitting an ACK or non-acknowledgement (NACK) (ACK/NACK) for the physical downlink shared channel (PDSCH) carrying the MAC CE with the command to apply the second common TCI ID, and may be determined based on the smallest SCS among all CCs in the set of CCs configured for the CA mode.

In the second subset of cases, in which the command to apply the second common TCI ID is received in DCI, the action delay may include a second time period, Y, in which a beam indicated by the TCI state associated with the second common TCI ID is applied to the set of CCs (e.g., a time period based on the information element (IE) BeamAppTime_r17 introduced in 3GPP Rel-17 for the CC having the smallest SCS). In these cases, the first time period (T_{ACK}) may include, or be equal to, 1) a HARQ ACK/NACK time period (e.g., T_{HARQ}) when the DCI includes a DL assignment for the UE, or 2) a predefined non-HARQ time period when the DCI does not include a DL assignment for the UE. The predefined non-HARQ time period, k, may be indicated by the RRC parameter dl-DataToUL-ACK or dl-DataToUL-ACK-r16 or dl-DataToUL-ACK-ForDCI-Format1-2. The action delay for the second subset of cases may therefore be T_{ACK}+Y, where T_{ACK} and Y are determined by the smallest SCS among all CCs in the set of CCs. A DCI-based common TCI ID switch is only applicable for cases in which the TCI state is known and the TCI state associated with the second common TCI ID is maintained in an active list by the UE.

In a third set of embodiments of the method 300, in which a RS is shared by the CCs in the set of CCs, the second common TCI ID may be provided for an UL TCI mode. The third set of embodiments may include a first subset of cases in which the command to apply the second common TCI ID is received in a MAC CE, and a second subset of cases in which the command to apply the second common TCI ID is received in DCI. In some cases, the UE switching behavior described below for the first and second subsets of cases may only apply to cases in which the TCI state associated with the common TCI ID is associated with a DL RS (and not to cases in which the TCI state is associated with a sounding reference signal (SRS), because a beam refinement time cannot be easily defined).

In the first subset of cases, in which the command to apply the second common TCI ID is received in a MAC CE, the action delay may include a second time period in which a MAC CE including the command received at 302 is decoded. The second time period may include the first time period. Optionally, the action delay may also include a third time period in which a Rx beam sweep is performed (i.e., a time for performing a Rx beam sweep) and/or a fourth time period in which a pathloss reference signal (PL-RS) is measured. The second time period may be equal to T_{HARQ} plus 3 ms. The third time period may be equal to T_{L1-RSRP}, and may be incurred (e.g., in FR2) when the TCI state associated with the second common TCI ID is unknown. The fourth time period may be equal to T_{first_target-PL-RS}+4*T_{target_PL-RS}+2 ms, and may be incurred when a measurement of the PL-RS is not already maintained by the UE. T_{first_target-PL-RS} is a time to a first PL-RS measurement, 4*T_{target_PL-RS} is a time to measure four instances of the PL-RS, and 2 ms is a delay for processing the PL-RS measurements. When the TCI state associated with the second common TCI ID is known, the action delay may be equal to T_{HARQ}+3 ms+NM*(T_{first_target-PL-RS}+4*T_{target_PL-RS}+2 ms), where NM is 1 if the PL-RS is not maintained, and NM is 0 if the PL-RS is maintained. When the TCI state associated with the second common TCI ID is unknown, the action delay may be equal to T_{HARQ}+3 ms+T_{L1-RSRP}+ (T_{first_target-PL-RS}+4*T_{target_PL-RS}+2 ms).

In the second subset of cases, in which the command to apply the second common TCI ID is received in DCI, the action delay may include a second time period, Y, in which a beam indicated by the TCI state associated with the second common TCI ID is applied to the set of CCs (e.g., a time period based on the IE BeamAppTime_r17 introduced in 3GPP Rel-17 for the CC having the smallest SCS). In these cases, the first time period (T_{ACK}) may include, or be equal to, 1) a HARQ ACK/NACK time period (e.g., T_{HARQ}) when the DCI includes a DL assignment for the UE, or 2) a predefined non-HARQ time period when the DCI does not include a DL assignment for the UE. The predefined non-HARQ time period, k, may be indicated by the RRC parameter dl-DataToUL-ACK or dl-DataToUL-ACK-r16 or dl-DataToUL-ACK-ForDCI-Format1-2. The action delay for the second subset of cases may therefore be T_{ACK}+Y, where T_{ACK} and Y are determined by the smallest SCS among all CCs in the set of CCs. A DCI-based common TCI ID switch is only applicable for cases in which the TCI state is known and the UE maintains a measurement of the PL-RS.

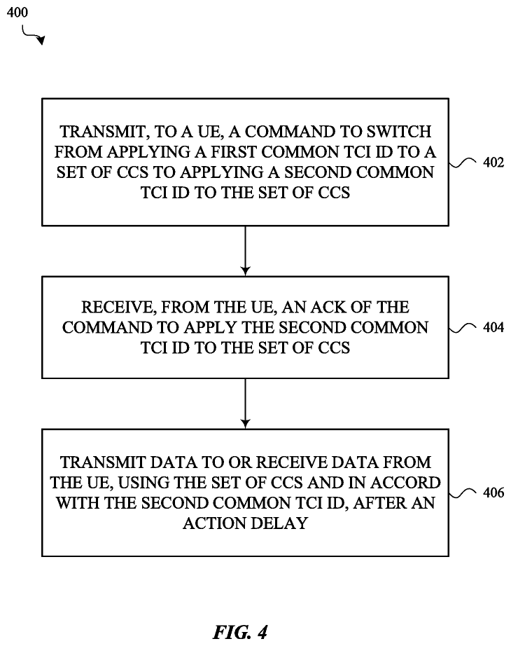

FIG. 4 shows an example method 400 of a base station, which method 400 may be used to switch a common TCI ID used by a UE. At the start of the method 400, the UE may be configured to communicate with the base station using a set of CCs configured for a CA mode, in accord with a first common TCI ID applied to the set of CCs. The set of CCs may include DL CCs and/or UL CCs, and the first common TCI ID may be applied to DL CCs and UL CCs (in a joint TCI mode), to only DL CCs (in a DL TCI mode), or to only UL CCs (in an UL TCI mode).

At block 402, the method 400 may include transmitting, to the UE, a command to switch from applying the first common TCI ID to the set of CCs to applying a second common TCI ID to the set of CCs.

At block 404, the method 400 may include receiving, from the UE, an ACK of the command to apply the second common TCI ID to the set of CCs.

At block 406, the method 400 may include transmitting data to or receiving data from the UE, using the set of CCs and in accord with the second common TCI ID, after an action delay. The action delay may include a first time period in which the acknowledgement is received at block 404. The first time period may be based on a smallest SCS of the set of CCs. The action delay may also be based on a smallest SCS of the set of CCs.

As described with reference to FIG. 3, the method 400 may be adapted in various ways, depending on factors such as: whether the second common TCI ID is associated with a TCI state/RS that is shared among the set of CCs; the TCI mode of the second common TCI ID (e.g., a joint TCI mode, a DL TCI mode, or an UL TCI mode); whether a TCI state associated with the second common TCI ID is known or unknown; or whether a command to switch to the second common TCI ID is received in a MAC CE or DCI.

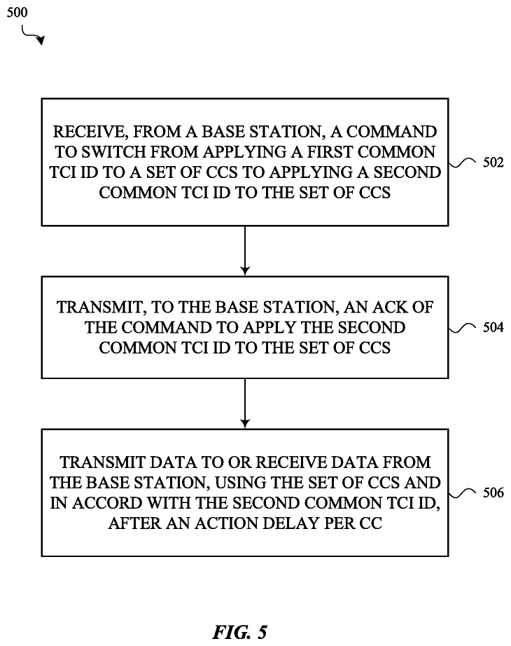

FIG. 5 shows another example method 500 of a UE, which method 500 may be used to switch a common TCI ID. At the start of the method 500, the UE may be configured to communicate with a base station using a set of CCs configured for a CA mode, in accord with a first common TCI ID applied to the set of CCs. The set of CCs may include DL CCs and/or UL CCs, and the first common TCI ID may be applied to DL CCs and UL CCs (in a joint TCI mode), to only DL CCs (in a DL TCI mode), or to only UL CCs (in an UL TCI mode).

At block 502, the method 500 may include receiving, from the base station, a command to switch from applying the first common TCI ID to the set of CCs to applying a second common TCI ID to the set of CCs.

At block 504, the method 500 may include transmitting, to the base station, an ACK of the command to apply the second common TCI ID to the set of CCs.

At block 506, the method 500 may include transmitting data to or receiving data from the base station, using the set of CCs and in accord with the second common TCI ID, after an action delay per CC. The action delay per CC may include a first time period in which the acknowledgement is transmitted at block 504. The first time period may be based on a smallest SCS of the set of CCs. The action delay may also be based on a smallest SCS of the set of CCs.

The method 500 may be adapted in various ways, depending on factors such as: whether the second common TCI ID is associated with a TCI state/RS that is shared among the set of CCs; the TCI mode of the second common TCI ID (e.g., a joint TCI mode, a DL TCI mode, or an UL TCI mode); whether a TCI state associated with the second common TCI ID is known or unknown; or whether a command to switch to the second common TCI ID is received in a MAC CE or DCI.

In some embodiments of the method 500, at least two different CCs in the set of CCs may be associated with different TCI states or different RSs according to the second common TCI ID. Because the TCI states or RSs are different, the set of CCs may not share a same QCL condition or same “known” or “unknown” condition. The UE behavior for beam training may also be different from one CC to another CC. The command decoding time may be based on the CC with the smallest SCS and may be the same for all of the CCs in the set of CCs, but the application time may differ. Because there may be a wide variance in the action delays for different CC, different CCs may be activated for use in accord with the second common TCI ID at different times.

In a first embodiment of the method 500, in which at least two of the CCs in the set of CCs do not share a TCI state or RS according to the second common TCI ID, the second common TCI ID may be provided for a DL TCI mode. The first set of embodiments may include a first subset of cases in which the command to apply the second common TCI ID is received in a MAC CE, and a second subset of cases in which the command to apply the second common TCI ID is received in DCI.

In the first subset of cases, in which the command to apply the second common TCI ID is received in a MAC CE, the action delay per CC may include a second time period in which a MAC CE including the command received at 502 is decoded. The second time period may include the first time period. Optionally, the action delay per CC, for at least one CC and less than all CCs in the set of CCs, may also include a third time period in which a Rx beam sweep is performed (i.e., a time for performing a Rx beam sweep) and/or a fourth time period in which a TO and a FO are acquired (i.e., a TO/FO acquisition time). The second time period may be equal to T_{HARQ} plus 3 milliseconds (3 ms). The third time period may be equal to T_{L1-RSRP}, and may be incurred (e.g., in FR2) when a TCI state associated with the second common TCI ID is unknown. The fourth time period may be equal to T_{first-SSB}+T_{SSB-proc}, and may be incurred when the second common TCI ID (or its associated TCI state) is not in an active list maintained by the UE. When a TCI state associated with the second common TCI ID is known, the action delay for a CC may be equal to T_{HARQ}+3 ms+TO_{K}*(T_{first-SSB}+T_{SSB-proc}), where TOₖ is 0 if the TO/FO is known and the second common TCI ID (or its associated TCI state) is in the active list, and 1 otherwise. When a TCI state associated with the second common TCI ID is unknown, the action delay for a CC may be equal to T_{HARQ}+3 ms+T_{L1-RSRP}+TOᵤₖ*(T_{first-SSB}+T_{SSB-proc}), where TOᵤₖ is 1 if the UE is not able to get the TO/FO during the T_{L1-RSRP} measurement, and 0 if the UE can get the TO/FO during the T_{L1-RSRP} measurement. The third time period and fourth time period, when applicable, may be calculated per CC, and may be different for different CCs. As a result, different CCs may have different action delays.

In the second subset of cases, in which the command to apply the second common TCI ID is received in DCI, the action delay per CC may include a second time period, Y, per CC in the set of CCs. The second time period for a CC is a time period in which a beam indicated by a per CC TCI state, associated with the second common TCI ID, is applied to a CC (e.g., a time period based on the IE BeamAppTime_r17 introduced in 3GPP Rel-17). In these cases, the first time period (T_{ACK}) may include, or be equal to, 1) a HARQ ACK/NACK time period (e.g., T_{HARQ}) when the DCI includes a DL assignment for the UE, or 2) a predefined non-HARQ time period when the DCI does not include a DL assignment for the UE. The predefined non-HARQ time period, k, may be indicated by the RRC parameter dl-DataToUL-ACK or dl-DataToUL-ACK-r16 or dl-DataToUL-ACK-ForDCI-Format1-2. The action delay per CC for the second subset of cases may therefore be T_{ACK}+Y, where Y is determined per CC. A DCI-based common TCI ID switch is only applicable for cases in which a TCI state for a CC is known and the TCI state is maintained in an active list by the UE.

In a second set of embodiments of the method 500, in which at least two of the CCs in the set of CCs do not share a TCI state or RS according to the second common TCI ID, the second common TCI ID may be provided for an UL TCI mode. The second set of embodiments may include a first subset of cases in which the command to apply the second common TCI ID is received in a MAC CE, and a second subset of cases in which the command to apply the second common TCI ID is received in DCI. In some cases, the UE switching behavior described below for the first and second subsets of cases may only apply to cases in which the TCI state(s) associated with the common TCI ID is/are associated with one or more DL RSs (and not to cases in which the TCI state(s) are associated with one or more SRSs, because a beam refinement time cannot be easily defined).

In the first subset of cases, in which the command to apply the second common TCI ID is received in a MAC CE, the action delay per CC may include a second time period in which a MAC CE including the command received at 502 is decoded. The second time period may include the first time period. Optionally, the action delay per CC may also include a third time period in which a Rx beam sweep is performed (i.e., a time for performing a Rx beam sweep) and/or a fourth time period in which a pathloss reference signal (PL-RS) is measured. The second time period may be equal to T_{HARQ} plus 3 ms. The third time period may be equal to T_{L1-RSRP}, and may be incurred (e.g., in FR2) when a TCI state associated with the second common TCI ID is unknown. The fourth time period may be equal to T_{first_target-PL-RS}+4*T_{target_PL-RS}+2 ms, and may be incurred when a measurement of a PL-RS is not already maintained by the UE. T_{first_target-PL-RS} is a time to a first PL-RS measurement, 4*T_{target_PL-RS} is a time to measure four instances of the PL-RS, and 2 ms is a delay for processing the PL-RS measurements. When a TCI state associated with the second common TCI ID is known, the action delay for a CC may be equal to T_{HARQ}+3 ms+NM*(T_{first_target-PL-RS}+4*T_{target_PL-RS}+2 ms), where NM is 1 if the PL-RS is not maintained, and NM is 0 if the PL-RS is maintained. When a TCI state associated with the second common TCI ID is unknown, the action delay for a CC may be equal to T_{HARQ}+3 ms+T_{L1-RSRP}+ (T_{first_target-PL-RS}+4*T_{target_PL-RS}+2 ms).

In the second subset of cases, in which the command to apply the second common TCI ID is received in DCI, the action delay per CC may include a second time period, Y, per CC in the set of CCs. The second time period for a CC is a time period in which a beam indicated by a per CC TCI state, associated with the second common TCI ID, is applied to a CC (e.g., a time period based on the IE BeamAppTime_r17 introduced in 3GPP Rel-17). In these cases, the first time period (T_{ACK}) may include, or be equal to, 1) a HARQ ACK/NACK time period (e.g., T_{HARQ}) when the DCI includes a DL assignment for the UE, or 2) a predefined non-HARQ time period when the DCI does not include a DL assignment for the UE. The predefined non-HARQ time period, k, may be indicated by the RRC parameter dl-DataToUL-ACK or dl-DataToUL-ACK-r16 or dl-DataToUL-ACK-ForDCI-Format1-2. The action delay per CC for the second subset of cases may therefore be T_{ACK}+Y, where Y is determined per CC. A DCI-based common TCI ID switch is only applicable for cases in which a TCI state for a CC is known and the UE maintains a measurement of the PL-RS.

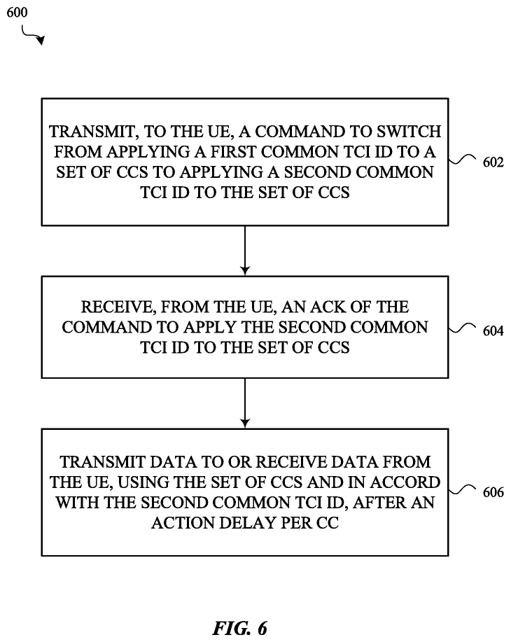

FIG. 6 shows another example method 600 of a base station, which method 600 may be used to switch a common TCI ID used by a UE. At the start of the method 400, the UE may be configured to communicate with the base station using a set of CCs configured for a CA mode, in accord with a first common TCI ID applied to the set of CCs. The set of CCs may include DL CCs and/or UL CCs, and the first common TCI ID may be applied to DL CCs and UL CCs (in a joint TCI mode), to only DL CCs (in a DL TCI mode), or to only UL CCs (in an UL TCI mode).

At block 602, the method 600 may include transmitting, to the UE, a command to switch from applying the first common TCI ID to the set of CCs to applying a second common TCI ID to the set of CCs.

At block 604, the method 600 may include receiving, from the UE, an ACK of the command to apply the second common TCI ID to the set of CCs.

At block 606, the method 600 may include transmitting data to or receiving data from the UE, using the set of CCs and in accord with the second common TCI ID, after an action delay per CC. The action delay per CC may include a first time period in which the acknowledgement is received at block 604. The first time period may be based on a smallest SCS of the set of CCs. The action delay may also be based on a smallest SCS of the set of CCs.

As described with reference to FIG. 5, the method 600 may be adapted in various ways, depending on factors such as: whether the second common TCI ID is associated with a TCI state/RS that is shared among the set of CCs; the TCI mode of the second common TCI ID (e.g., a joint TCI mode, a DL TCI mode, or an UL TCI mode); whether a TCI state associated with the second common TCI ID is known or unknown; or whether a command to switch to the second common TCI ID is received in a MAC CE or DCI.

Embodiments contemplated herein include an apparatus having means to perform one or more elements of the method 300, 400, 500, or 600. In the context of method 300 or 500, this apparatus may be, for example, an apparatus of a UE (such as a wireless device 802 that is a UE, as described herein). In the context of method 400 or 600, this apparatus may be, for example, an apparatus of a base station (such as a network device 820 that is a base station, as described herein).

Embodiments contemplated herein include one or more non-transitory computer-readable media storing instructions to cause an electronic device, upon execution of the instructions by one or more processors of the electronic device, to perform one or more elements of the method 300, 400, 500, or 600. In the context of method 300 or 500, this non-transitory computer-readable media may be, for example, a memory of a UE (such as a memory 806 of a wireless device 802 that is a UE, as described herein). In the context of method 400 or 600, this non-transitory computer-readable media may be, for example, a memory of a base station (such as a memory 824 of a network device 820 that is a base station, as described herein).

Embodiments contemplated herein include an apparatus having logic, modules, or circuitry to perform one or more elements of the method 300, 400, 500, or 600. In the context of method 300 or 500, this apparatus may be, for example, an apparatus of a UE (such as a wireless device 802 that is a UE, as described herein). In the context of method 400 or 600, this apparatus may be, for example, an apparatus of a base station (such as a network device 820 that is a base station, as described herein).

Embodiments contemplated herein include an apparatus having one or more processors and one or more computer-readable media, using or storing instructions that, when executed by the one or more processors, cause the one or more processors to perform one or more elements of the method 300, 400, 500, or 600. In the context of method 300 or 500, this apparatus may be, for example, an apparatus of a UE (such as a wireless device 802 that is a UE, as described herein). In the context of method 400 or 600, this apparatus may be, for example, an apparatus of a base station (such as a network device 820 that is a base station, as described herein).

Embodiments contemplated herein include a signal as described in or related to one or more elements of the method 300, 400, 500, or 600.

Embodiments contemplated herein include a computer program or computer program product having instructions, wherein execution of the program by a processor causes the processor to carry out one or more elements of the method 300, 400, 500, or 600. In the context of method 300 or 500, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 400 or 600, the processor may be a processor of a base station (such as a processor(s) 822 of a network device 820 that is a base station, as described herein), and the instructions may be, for example, located in the processor and/or on a memory of the base station (such as a memory 824 of a network device 820 that is a base station, as described herein).

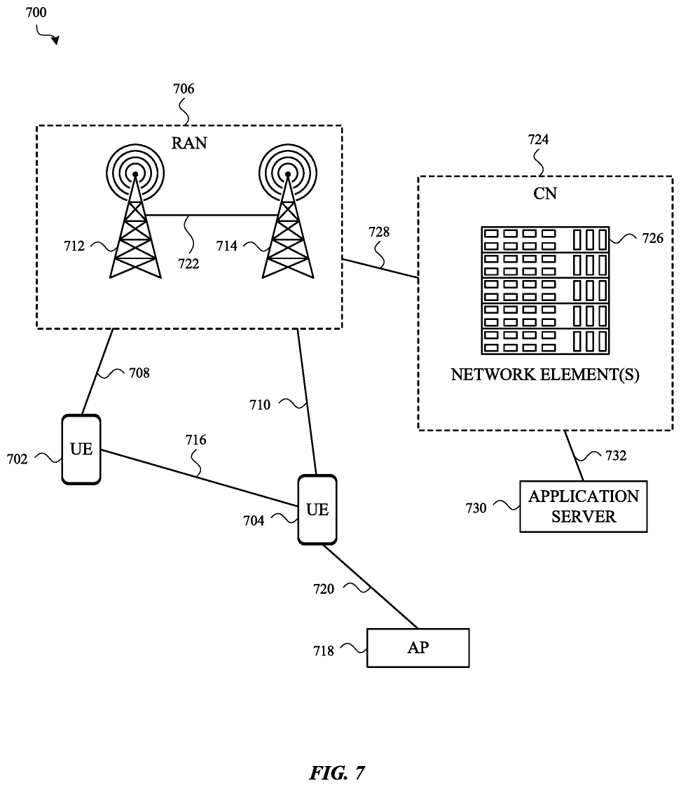

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VOIP sessions, group communication sessions, etc.) for the UE 702 and UE 704 via the CN 724. The application server 730 may communicate with the CN 724 through an IP communications interface 732.

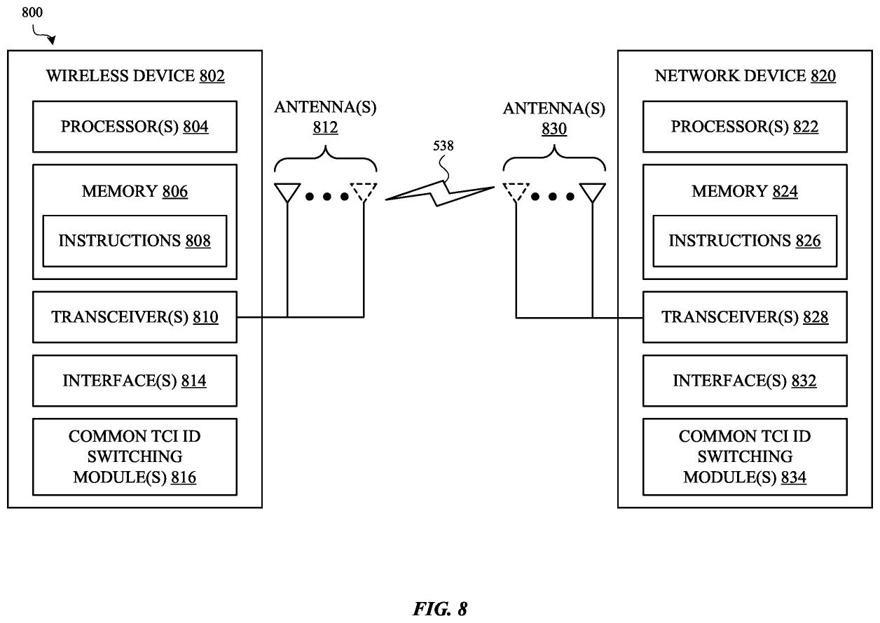

FIG. 8 illustrates a system 800 for performing signaling 838 between a wireless device 802 and a network device 820, according to embodiments disclosed herein. The system 800 may be a portion of a wireless communications system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a common TCI ID switching module 816. The common TCI ID switching module 816 may be implemented via hardware, software, or combinations thereof. For example, the common TCI ID switching module 816 may be implemented as a processor, circuit, and/or instructions 808 stored in the memory 806 and executed by the processor(s) 804. In some examples, the common TCI ID switching module 816 may be integrated within the processor(s) 804 and/or the transceiver(s) 810. For example, the common TCI ID switching module 816 may be implemented by a combination of software components (e.g., executed by a DSP or a general processor) and hardware components (e.g., logic gates and circuitry) within the processor(s) 804 or the transceiver(s) 810.

The common TCI ID switching module 816 may be used for various aspects of the present disclosure, for example, aspects of FIG. 1 through FIG. 6. The common TCI ID switching module 816 may be configured to, for example, report UE capability information to another device (e.g., the network device 820).

The network device 820 may include one or more processor(s) 822. The processor(s) 822 may execute instructions such that various operations of the network device 820 are performed, as described herein. The processor(s) 804 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828 and antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

The network device 820 may include a common TCI ID switching module 834. The common TCI ID switching module 834 may be implemented via hardware, software, or combinations thereof. For example, the common TCI ID switching module 834 may be implemented as a processor, circuit, and/or instructions 826 stored in the memory 824 and executed by the processor(s) 822. In some examples, the common TCI ID switching module 834 may be integrated within the processor(s) 822 and/or the transceiver(s) 828. For example, the common TCI ID switching module 834 may be implemented by a combination of software components (e.g., executed by a DSP or a general processor) and hardware components (e.g., logic gates and circuitry) within the processor(s) 822 or the transceiver(s) 828.

The common TCI ID switching module 834 may be used for various aspects of the present disclosure, for example, aspects of FIG. 1 through FIG. 6. The common TCI ID switching module 834 may be configured to, for example, receive UE capability information from another device (e.g., the wireless device 802).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE) configured to communicate with a base station using a set of component carriers (CCs) including a set of downlink (DL) CCs and a set of uplink (UL) CCs, the UE comprising:
a processor configured to,
receive from the base station, via a transceiver, a command to switch from applying a first common transmission configuration indication (TCI) identifier (ID) to the set of CCs to applying a second common TCI ID to the set of CCs, the second common TCI ID provided for a joint TCI mode;
simultaneously begin to switch the DL CCs and the UL CCs to the second common TCI ID;
transmit to the base station, via the transceiver, an acknowledgement of the command to apply the second common TCI ID to the set of CCs;
receive from the base station, via the transceiver, a reference signal (RS) shared by CCs in the set of CCs according to the second common TCI ID; and
transmit data to or receive data from the base station, via the transceiver, using the set of CCs and in accord with the second common TCI ID.

2. The UE of claim 21, wherein:
the action delay includes a downlink action delay and an uplink action delay; and
the processor is configured to,
receive a downlink communication from the base station, via the transceiver, after the downlink action delay; and
transmit an uplink communication to the base station, via the transceiver, after the uplink action delay.

3. The UE of claim 21, wherein:
the action delay includes a downlink action delay and an uplink action delay;
both of the downlink action delay and the uplink action delay include the first time period; and
the processor is configured to,
determine a maximum of the downlink action delay and the uplink action delay; and
transmit data to or receive data from the base station, via the transceiver, after the maximum of the downlink action delay and the uplink action delay.

4-20. (canceled)

21. The UE of claim 1, wherein the processor is configured to transmit the data to or receive the data from the base station, via the transceiver, using the set of CCs and in accord with the second common TCI ID, after an action delay including a first time period in which the acknowledgement is transmitted.

22. The UE of claim 21, wherein the first time period is based on a smallest subcarrier spacing (SCS) of the set of CCs.

23. The UE of claim 1, wherein the command to apply the second common TCI ID to the set of CCs is received in a medium access control (MAC) control element (CE).

24. The UE of claim 1, wherein the command to apply the second common TCI ID to the set of CCs is received in downlink control information (DCI).

25. The UE of claim 1, wherein the first common TCI ID is provided for a joint TCI mode.

26. The UE of claim 1, wherein the first common TCI ID is provided for a DL TCI mode.

27. The UE of claim 1, wherein the first common TCI ID is provided for an UL TCI mode.

28. The UE of claim 1, wherein the processor is configured to transmit the data to or receive the data from the base station, via the transceiver, using the set of CCs and in accord with the second common TCI ID, after an action delay based on a smallest subcarrier spacing (SCS) of the set of CCs.

29. A method of a user equipment (UE), the method for communicating with a base station using a set of component carriers (CCs) including a set of downlink (DL) CCs and a set of uplink (UL) CCs, the method comprising:
receiving a command to switch from applying a first common transmission configuration indication (TCI) to the set of CCs to applying a second common TCI ID to the set of CCs, the second common TCI ID provided for a joint TCI mode;
simultaneously beginning to switch the DL CCs and the UL CCs to the second common TCI ID;
transmitting an acknowledgement of the command to apply the second common TCI ID to the set of CCs;
receiving a reference signal (RS) shared by CCs in the set of CCs according to the second common TCI ID; and
transmitting data to or receive data from the base station, via the transceiver, using the set of CCs and in accord with the second common TCI ID.

30. The method of claim 29, further comprising:
transmitting the data to or receiving the data from the base station, using the set of CCs and in accord with the second common TCI ID, after an action delay including a first time period in which the acknowledgement is transmitted, the first time period based on a smallest subcarrier spacing (SCS) of the set of CCs.

31. The method of claim 30, wherein the action delay includes a downlink action delay and an uplink action delay, and the method further comprises:
receiving a downlink communication from the base station, via the transceiver, after the downlink action delay; and
transmitting an uplink communication to the base station, via the transceiver, after the uplink action delay.

32. The method of claim 30, wherein the action delay includes a downlink action delay and an uplink action delay, both of the downlink action delay and the uplink action delay include the first time period, and the method further comprises:
determining a maximum of the downlink action delay and the uplink action delay; and
transmitting data to or receive data from the base station, via the transceiver, after the maximum of the downlink action delay and the uplink action delay.

33. A baseband processor comprising a memory and configured to communicate with a base station using a set of component carriers (CCs) including a set of downlink (DL) CCs and a set of uplink (UL) CCs, the baseband processor configured to:
receive a command to switch from applying a first common transmission configuration indication (TCI) to the set of CCs to applying a second common TCI ID to the set of CCs, the second common TCI ID provided for a joint TCI mode;
simultaneously begin to switch the DL CCs and the UL CCs to the second common TCI ID;
transmit an acknowledgement of the command to apply the second common TCI ID to the set of CCs;
receive a reference signal (RS) shared by CCs in the set of CCs according to the second common TCI ID; and
transmit data to or receive data from the base station, via the transceiver, using the set of CCs and in accord with the second common TCI ID.

34. The baseband processor of claim 33, further configured to transmit the data to or receive the data from the base station, using the set of CCs and in accord with the second common TCI ID, after an action delay including a first time period in which the acknowledgement is transmitted.

35. The baseband processor of claim 34, wherein the first time period is based on a smallest subcarrier spacing (SCS) of the set of CCs.

36. The baseband processor of claim 34, wherein:
the action delay includes a downlink action delay and an uplink action delay; and
the baseband processor is configured to,
receive a downlink communication from the base station, via the transceiver, after the downlink action delay; and
transmit an uplink communication to the base station, via the transceiver, after the uplink action delay.

37. The baseband processor of claim 34, wherein:
the action delay includes a downlink action delay and an uplink action delay;
both of the downlink action delay and the uplink action delay include the first time period; and
the baseband processor is configured to,
determine a maximum of the downlink action delay and the uplink action delay; and
transmit data to or receive data from the base station, via the transceiver, after the maximum of the downlink action delay and the uplink action delay.
